(19) United States
(12) Patent Application Publication
(10) Pub. No.: US 2023/0350174 A1
(43) Pub. Date: Nov. 2, 2023

(54) Viewing Optic with Magnification Adjustment Ring

(71) Applicant: Sheltered Wings, Inc. d/b/a Vortex Optics, Barneveld, WI (US)

(72) Inventor: Connor McDermot, Barneveld, WI (US)

(21) Appl. No.: 18/052,809

(22) Filed: Nov. 4, 2022

Related U.S. Application Data
(60) Provisional application No. 63/275,658, filed on Nov. 4, 2021.

(51) Int. Cl. G02B 15/15; F41G 1/38

(52) U.S. Cl. CPC G02B 15/15; F41G 1/38

(57) ABSTRACT

The disclosure relates to a magnification adjusting assembly. In one embodiment, the magnification adjusting assembly comprises a ring having an inner surface and an outer surface. In one embodiment, a groove is disposed around the inner surface of the ring. In one embodiment, at least three ball bearing structures are secured in the groove by a compressible material.

### CROSS-REFERENCE TO RELATED APPLICATIONS

This application is a non-provisional patent application of and claims priority to U.S. Provisional Patent Application No. 63/275,658 filed Nov. 5, 2021, which is incorporated herein by reference in its entirety.

### FIELD

The disclosure relates to a viewing optics. In one embodiment, the disclosure relates to a viewing optic containing a magnification adjustment ring. In one embodiment, the disclosure relates to a method of preventing a magnification adjustment ring from moving along the primary axis of a viewing optic and axial load transfer.

### BACKGROUND

Magnification adjustment rings are provided on the outside of the main body of a viewing optic to be manipulated to adjust the magnification of the viewing optic. Existing magnification adjustment rings have a single threaded hole in which a threaded pin is fastened. The pin extends into a slot in the scope body. The pin body is constrained between the walls of the slot in the scope body, and any clearance between the walls and the pin body permits unwanted axial translation of the magnification adjusting ring. The pin body extends further into the erector tube of the viewing optic to adjust the magnification of the telescoping optic. Only this single pin extends into the scope tube, and this single pin is the only method of retention for the magnification adjustment ring. The single pin can provide uneven retention and localized loading of external forces on the magnification adjustment ring.

More specifically, angular constraint in existing magnification adjusting rings relies on end points of the slot in the scope body. As the threaded pin is rotated about the primary axis of the scope body, the pin body extends further into the slot of the erector tube. This constraint rotates the erector tube until the threaded pin contacts one of the end points. Any clearance between the pin body and the slot walls could allow for improper rotational placement of the erector tube, thus causing deviations in maximum and minimum magnification. Repeated contact with the end points can also cause wallowing and bending of the pin, thus compromising waterproofness and worsening rotational positioning of the magnification adjusting ring.

For the reasons discussed above, providing a magnification adjustment ring with improved connection between it and the scope tube and/or with more evenly distributed load applied around the circumference of the magnification adjusting ring is advantageous.

### SUMMARY

In one embodiment, the disclosure provides a magnification adjusting assembly. In accordance with embodiments of the disclosure, a magnification adjusting assembly comprises a ring having an inner surface and an outer surface; a groove disposed around the inner surface of the ring; and a ball bearing structure secured in the groove by a compressible material. In one embodiment, at least three ball bearing structures are secured in the groove by a compressible material.

In an embodiment, the compressible material is an o-ring. In an embodiment, the ring has a texture over at least a portion of the outer surface. In a further embodiment, the outer surface includes at least one fin. In another embodiment, the magnification adjusting assembly comprises numerical indicia on a portion of the outer surface.

In one embodiment, the disclosure provides a viewing optic. In accordance with embodiments of the disclosure, a viewing optic comprises a body having an outer surface and rear end comprising a plurality of holes spaced about the body; a movable optical element defining an optical axis connected to the body; an adjusting ring assembly comprising a ring having a inner surface and an outer surface; a groove disposed around the inner surface of the ring; and a plurality of ball bearing structures, each corresponding to one of the plurality of holes, wherein the ball bearing structures are secured between the groove and the respective hole by a compressible material.

In an embodiment, the ball bearings are secured between the groove and the respective hole such that from greater than 50% to 75% of the ball bearings remain below the outer surface of the body. In another embodiment, the compressible material is an o-ring. In a further embodiment, the plurality of holes comprises three holes. In yet another embodiment, the holes are positioned from 215°-235°, 300°-60° and 105°-115°, respectively.

In an embodiment, the viewing optic is a rifle scope. In a further embodiment, the adjusting ring is a magnification adjusting ring.

In one embodiment, the disclosure provides a method of retaining an adjusting ring on a viewing optic, the method comprising: providing a viewing optic body with a plurality of holes; placing an adjusting ring over the body such that a groove on the interior of the adjustment ring aligns with the plurality of holes; rotating the adjusting ring about the body until at least one hole in the adjusting ring aligns with at least one hole of the body; pushing a compressible material through the hole in the adjusting ring; pushing a ball bearing through the hole and into the adjusting ring; rotating the adjusting ring about the body while compressing the compressible material using the ball bearing; and repeating the pushing a compressible material, pushing a ball bearing, and rotating the adjusting ring about the body while compressing the compressible material using the ball bearing until each of the plurality of holes contains a compressible material and a ball bearing.

### BRIEF DESCRIPTION OF THE DRAWINGS

Embodiments of the disclosure are disclosed with reference to the accompanying drawings and are for illustrative purposes only. The disclosure is not limited in its application to the details of construction or the arrangement of the components illustrated in the drawings. The disclosure is capable of other embodiments or of being practiced or carried out in other various ways. Like reference numerals are used to indicate like components. In the drawings:

FIG. 1 is a side view of an embodiment of a rifle scope in accordance with embodiments of the disclosure.

FIG. 2 is a cross-sectional view of the rifle scope of FIG. 1 taken along line 2-2 in accordance with embodiments of the disclosure.

FIG. 3A is a partial right side perspective view of a rifle scope showing the rear end configured to receive a magnification adjusting ring in accordance with embodiments of the disclosure.

FIG. 3B is a partial left side perspective view of the rifle scope showing the rear end configured to receive a magnification adjusting ring in accordance with embodiments of the disclosure.

FIG. 3C is a cross-sectional view taken along line 3C-3C of FIG. 3A.

FIG. 4A is a partial right side perspective view of a further rifle scope showing the rear end configured to receive a magnification adjusting ring in accordance with embodiments of the disclosure.

FIG. 4B is a ride side view of a the rifle scope of FIG. 4A.

FIG. 4C is a cross-sectional view taken along line A-A of FIG. 4B.

FIG. 4D is a cross-sectional view taken along line B-B of FIG. 4B.

FIG. 5 is a cross-sectional schematic of the rear end of the rifle scope of FIGS. 3A-3C with a magnification adjusting ring in place in accordance with embodiments of the disclosure.

FIG. 6A is a perspective view of a portion of the magnification adjusting ring of FIG. 5 in accordance with embodiments of the disclosure.

FIG. 6B is a cross-sectional view of a portion of FIG. 6A.

FIG. 7A is a right side view of a further magnification adjusting ring in accordance with embodiments of the disclosure.

FIG. 7B is a rear side view of the magnification adjusting ring of FIG. 7A.

FIG. 7C is a cross-sectional view taken along the line A-A of FIG. 7B.

FIG. 7D is a front side view of the magnification adjusting ring of FIG. 7A.

FIG. 7E is a right perspective view of the magnification adjusting ring of FIG. 7A.

FIG. 7F a bottom view of the magnification adjusting ring of FIG. 7A.

FIG. 7G is an enlarged view of portion F shown in FIG. 7F.

FIG. 7H is a cross-sectional view taken along line E-E of FIG. 7B.

Before explaining embodiments of the disclosure in detail, it is to be understood that the disclosure is not limited in its application to the details of construction and the arrangement of the components set forth in the following description or illustrated in the drawings. The technology of this present disclosure is capable of other embodiments or being practiced or carried out in various ways. Also, it is to be understood that the phraseology and terminology employed herein is for the purpose of description and should not be regarded as limiting.

### DETAILED DESCRIPTION

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, melt index, temperature, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, relative amounts of components in a mixture, and various temperature and other parameter ranges recited in the methods.

The term “about,” as used herein in conjunction with a numerical range, modifies that range by extending the boundaries above and below the numerical values set forth. In one embodiment, the term “about” is used herein to modify a numerical value above and below the stated value by a variance of 10%. Therefore, about 50% includes the range of 45%-55%.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, the terms “comprising,” “including,” “having” and like terms are not intended to exclude the presence of any additional component, step or procedure, whether or not the same is specifically disclosed. In order to avoid any doubt, all processes claimed through use of the term “comprising” may include one or more additional steps, pieces of equipment or component parts, and/or materials unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or,” unless stated otherwise, refers to the listed members individually as well as in any combination.

As used herein, an “erector sleeve” is a protrusion from the erector lens mount which engages a slot in the erector tube and/or cam tube or which serves an analogous purpose. This could be integral to the mount or detachable.

As used herein, an “erector tube” is any structure or device having an opening to receive an erector lens mount.

As used herein, the term “magnification adjusting ring” and “magnification adjustment ring” are used interchangeably.

As used herein, the term “viewing optic” refers to an apparatus used by a shooter or a spotter to select, identify or monitor a target. The “viewing optic” may rely on visual observation of the target, or, for example, on infrared (IR), ultraviolet (UV), radar, thermal, microwave, or magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to the shooter by the “viewing optic” device may be unaltered, or it may be enhanced, for example, by magnification, amplification, subtraction, superimposition, filtration, stabilization, template matching, or other means. The target selected, identified or monitored by the “viewing optic” may be within the line of sight of the shooter, or tangential to the sight of the shooter, or the shooter's line of sight may be obstructed while the target acquisition device presents a focused image of the target to the shooter. The image of the target acquired by the “viewing optic” may be, for example, analog or digital, and shared, stored, archived, or transmitted within a network of one or more shooters and spotters by, for example, video, physical cable or wire, IR, radio wave, cellular connections, laser pulse, optical, 802.11b or other wireless transmission using, for example, protocols such as html, SML, SOAP, X.25, SNA, etc., Bluetooth™, Serial, USB or other suitable image distribution method. The term “viewing optic” is used interchangeably with “optic sight.”

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a standalone weapons sight, front-mount or rear-mount clip-on weapons site, and other permutations of filed deployed optical weapons sights. Further, it will be appreciated by those skilled in the art that various combinations of features and capabilities may be incorporated into add-on modules for retrofitting existing fixed or variable weapons sights of any variety.

It will be understood that when an element or layer is referred to as being “on,” “connected to” or “coupled to” another element or layer, it can be directly on, connected or coupled to the other element or layer. Alternatively, intervening elements or layers may be present. In contrast, when an element is referred to as being “directly on,” “directly connected to” or “directly coupled to” another element or layer, there are no intervening elements or layers present.

Like numbers refer to like elements throughout. As used herein, the term “and/or” includes any and all combinations of one or more of the associated listed items.

It will be understood that, although the terms first, second, etc., may be used herein to describe various elements, components, regions, and/or sections, these elements, components, regions, and/or sections should not be limited by these terms. These terms are only used to distinguish one element, component, region, or section from another element, component, region, or section. Thus, a first element, component, region, or section discussed below could be termed a second element, component, region, or section without departing from the disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

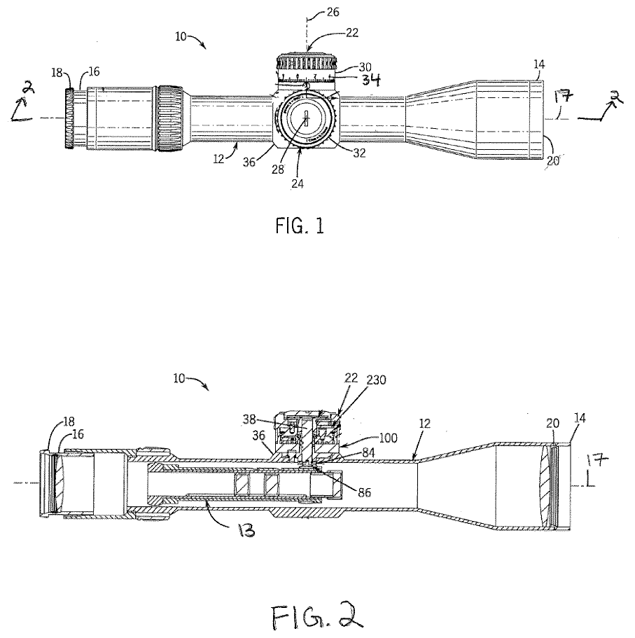

FIGS. 1-2 illustrate a rifle scope 10, generally, in accordance with embodiments of the disclosure. The rifle scope 10 has a body 12 that encloses a movable optical element 13, which is an erector tube. The scope body 12 is an elongate tube having a larger opening at its front 14 and a smaller opening at its rear 16. An eyepiece 18 is attached to the rear of the scope body 12, and an objective lens 20 is attached to the front of the scope body 12. The center axis of the movable optical element 13 defines the optical axis 17 of the rifle scope 10.

An elevation turret 22 and a windage turret 24 are two knobs in the outside center part of the scope body 12. They are marked in increments by indicia 34 on their perimeters 30 and 32 and are used to adjust the elevation and windage of the movable optical element 13 for points of impact change. These knobs 22, 24 protrude from the turret housing 36. The turrets 22, 24 are arranged so that the elevation turret rotation axis 26 is perpendicular to the windage turret rotation axis 28. Indicia typically include tick marks, each corresponding to a click, and larger tick marks at selected intervals, as well as numerals indicating angle of adjustment or distance for bullet drop compensation.

The movable optical element 13 is adjusted by rotating the turrets one or more clicks. A click is one tactile adjustment increment on the windage or elevation turret of the rifle scope 10, each of which corresponds to one of the indicial 34. In the current embodiment, one click changes the scope's point of impact by 0.1 milliradians (mrad). However, the turrets, systems and concepts disclosed herein can be used with other measures of increments. In other embodiments, the increments can be minutes of angle (MOA) increments.

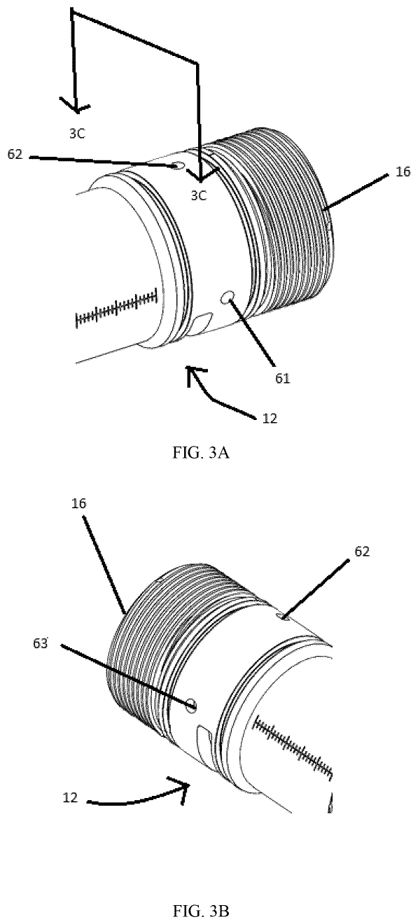

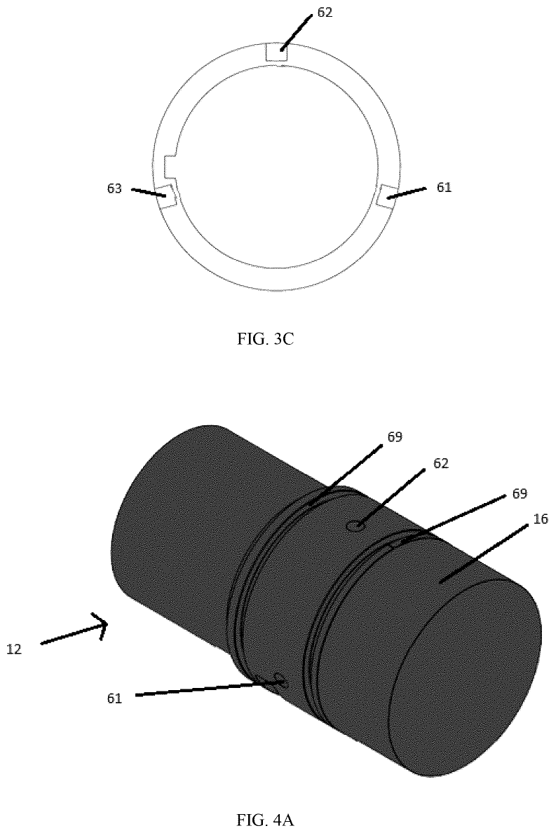

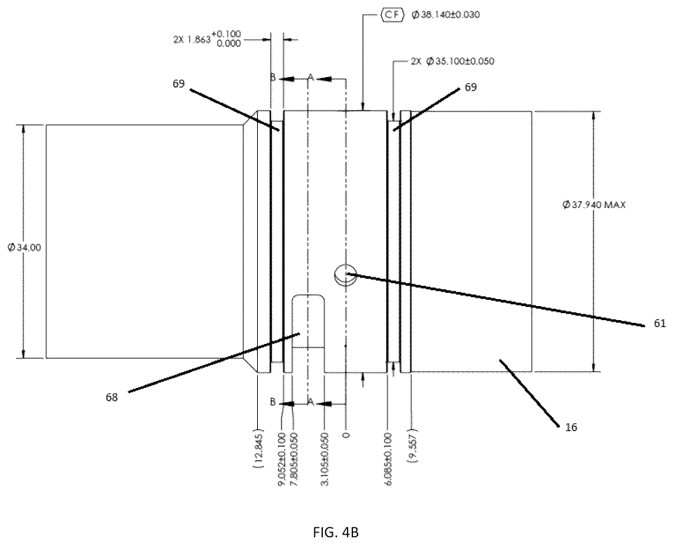

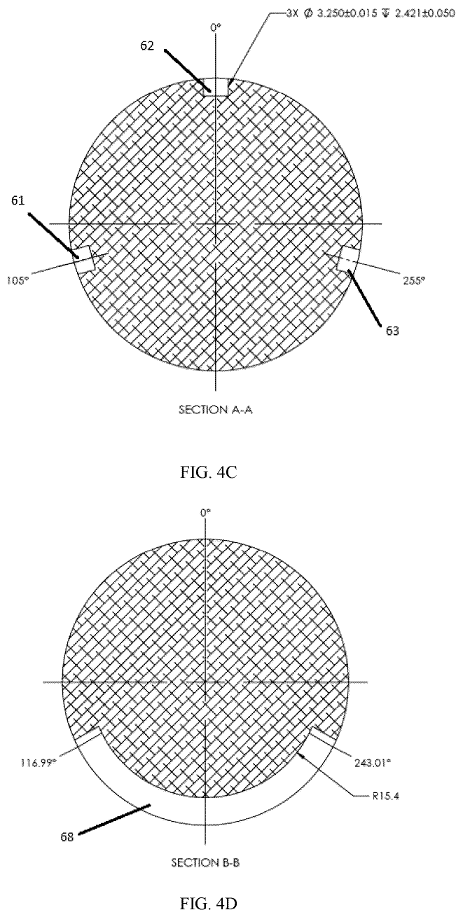

FIGS. 3A-3C and 4A-4D illustrate first and second embodiments, respectively, of the rear end 16 with the magnification adjusting ring removed. As shown in FIGS. 3A-3C and 4A-4D, the body 12 has a plurality of bottoming holes spaced around an outer diameter of the body 12. Particularly, in the embodiment shown, there are three bottoming holes 61, 62, 63. Additional holes may be provided. A groove 68 is further provided in the scope body 12.

In the embodiments shown in FIGS. 3A-3C and 4A-4D, the holes 61, 62 and 63 are positioned about the scope body at 225°, 0° and 105°, respectively. In further embodiments, the holes 61, 62, and 63 can be positioned from 215°-235°, 300°-60° and 105°-115°, respectively. In still further embodiments, the holes 61, 62 and 63 may be positioned evenly about the scope body 12 or at different intervals. The groove 68 is shown as extending from approximately 117° to 243°, though in some embodiments the groove 68 may be longer, short or oriented at a different position about the scope body 12 provided, however, that the groove 68 does not overlap with or interfere with the holes 61, 62 and 63.

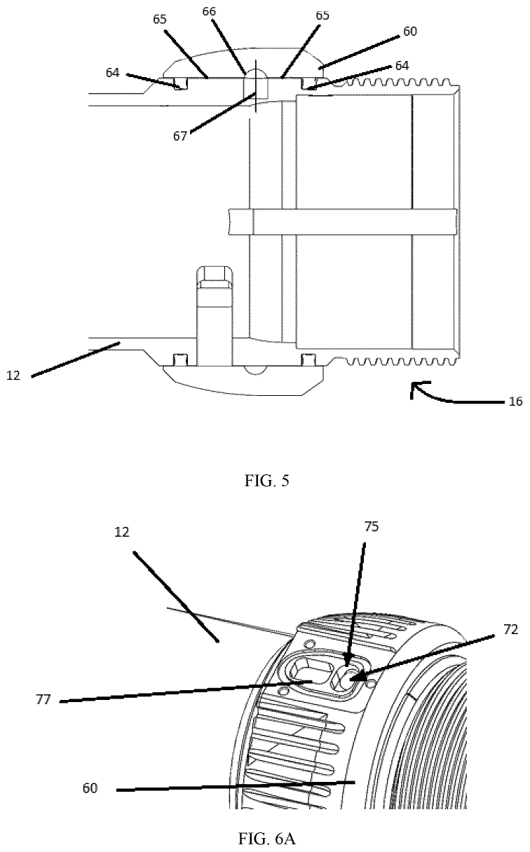

The holes (e.g., 61, 62, 63) are located on the rear end 16 at a spot at which they can be sealed from the exterior with the magnification adjusting ring 60 as shown in FIG. 5. The magnification adjusting ring 60 is positioned on the outside of the body 12 at the rear end 16 and covers the plurality of holes (e.g., 61, 62, 63) in the body 12.

The inner diameter or profile of the magnification adjusting ring 60 is precisely designed to match the contours and features of the body 12 over which it is positioned. In the embodiment shown in FIG. 5, the magnification adjusting ring 60 has two bore portions 65 which interface with two sealing components 64. The sealing components 64 engage ring grooves 69 around the scope body 12, as shown with reference to FIGS. 4A and 4B. The sealing components 64 may be o-rings, x-rings, or similar structures. The internal profile of the magnification adjusting ring 60 also includes a groove 66 that, when installed correctly, has a mid-plane line 67 coincident with the axis of the holes (e.g., 61, 62, 63) in the scope body 12.

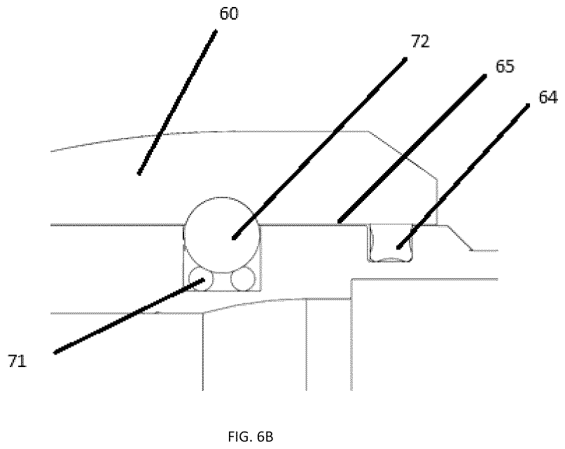

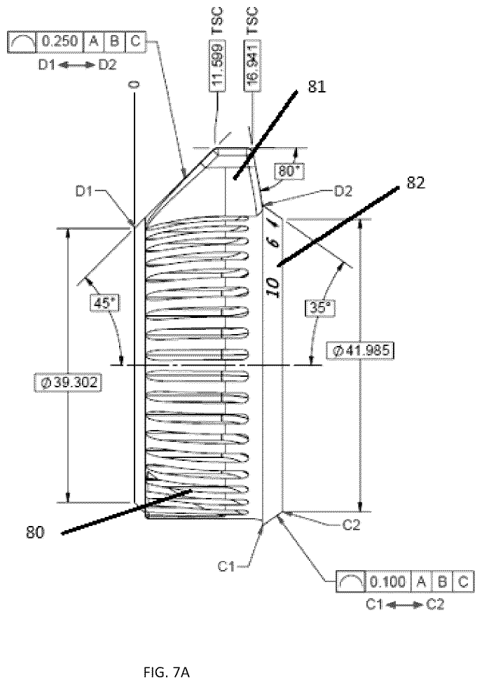

To retain the magnification adjusting ring 60, a mechanical interface must be installed into the plurality of holes (e.g., 61, 62, 63) in the body 12. In the embodiment shown, the mechanical interface is composed of two elements—a compressible component 71 and a ball bearing 72, as shown in FIGS. 6A and 6B. The compressible component 71 and ball bearing 72 are inserted through a hole 75 in the magnification adjusting ring 60. Once a first hole 61, 62 or 63 contains a compressible component 71 and a ball bearing 72, the magnification adjusting ring 60 is rotated so that its hole 75 aligns with the next hold 61, 62 or 63 of the body 12. The magnification adjusting ring 60 together with the compressible components 71 and ball bearings 72 from a magnification adjusting assembly.

The magnification adjusting ring 60 includes a second hole 77 which aligns with the groove 68 of the scope body 12.

While in the embodiment shown, the mechanical interface is made of two structures, a compressible component 71, which is shown as an o-ring, and a metallic ball bearing 72. It will be appreciated that the compressible component 71 does not need to be an o-ring, and the ball bearing 72 does not need to be metallic. In further embodiments, different structures of compressible materials may be used, such as polymer pads, springs, and similar structures Likewise, the ball bearing 72 maybe any material or structure capable of compressing the compressible material 71 and creating the mechanical interface. In still further embodiments, the compressible material 71 and ball bearing 72 may be a single structure, such as, for example, a polymer pin.

The ball bearing 72 extends out of the holes 61, 62, 63 and partly engage the corresponding groove 66. In the embodiment shown, and in order to create a sufficient mechanical interface, greater than 50% of the ball bearing 72 remains below the surface of the scope body 12 when in the properly installed position. The remainder of the ball bearing 72 engages the groove 66 of the magnification adjusting ring 60. In some embodiments, from about greater than 50%, or 55%, or 60% to 65%, or 70%, or 75% of the ball bearing 72 remains below the surface of the scope body 12.

In the embodiment shown, the holes 61, 62 and 63 are spaced angularly in an orientation such that when each of the holes 61, 62, and 63 contains a compressible material 71 and ball bearing 72, the hole 10 in the magnification adjusting ring 60 cannot cross a ball bearing 71.

In using three points of contact for retaining the magnification adjusting ring 60 to the scope body 12, the bending seen with traditional single screw retention structures is prevented. Axial displacement of the magnification adjusting ring 60 is also prevented while maintaining operation similar to existing magnification adjusting rings 60. The end result is a durable and structurally rigid connection between the magnification adjusting ring 60 and the scope body 12 with familiarity of use to the end user.

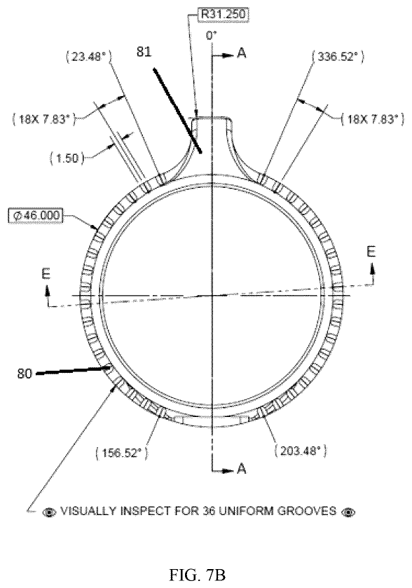

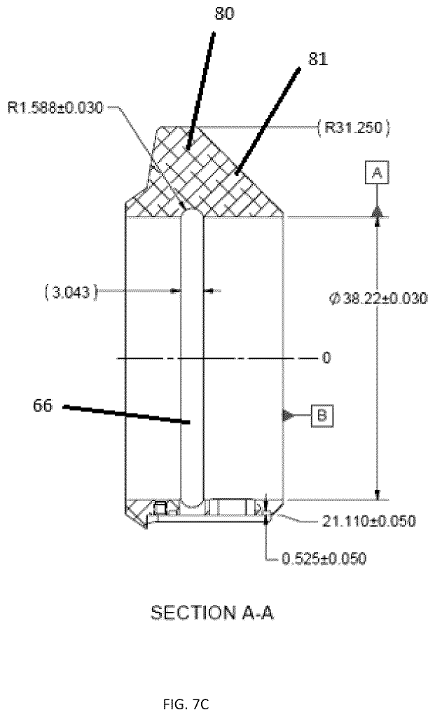

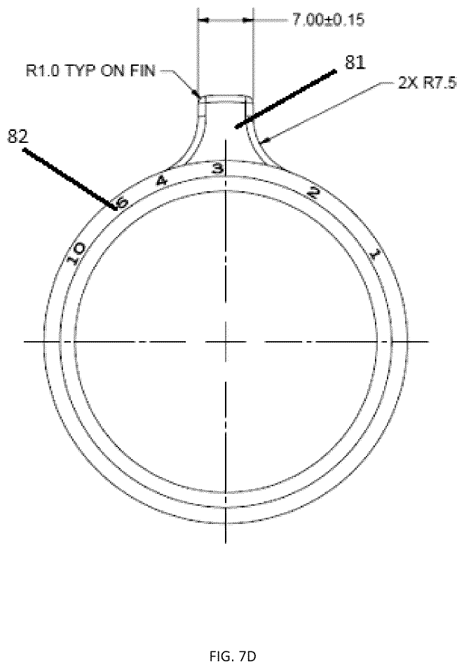

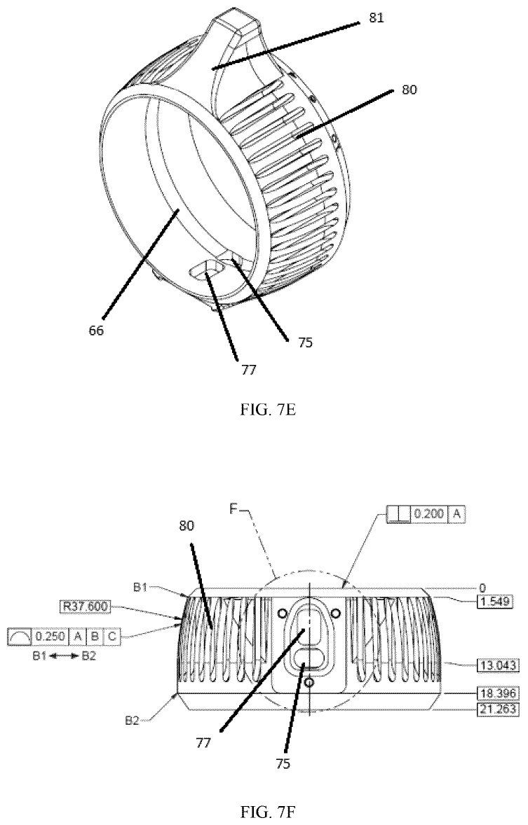

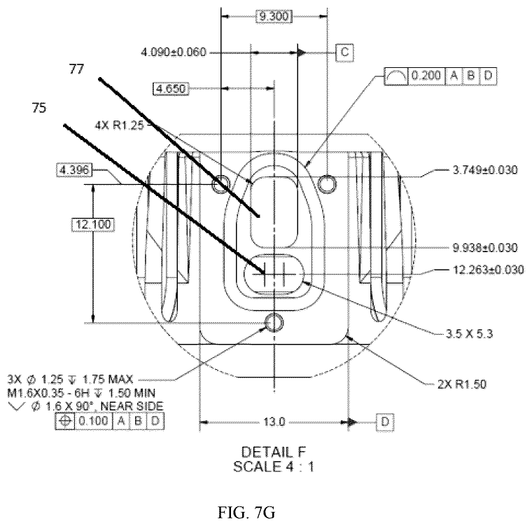

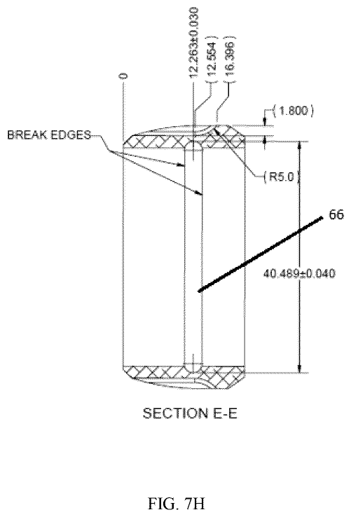

FIGS. 7A-7H illustrate a further embodiment of a magnification adjusting ring 60. In the embodiment shown in FIGS. 7A-7H, the outer surface of the ring 60 has a texture 80 and a fin 81 which a user uses to grip and rotate the magnification adjusting ring 60. Adjacent the textured surface 80 nearest the fin 81, and on the side of the magnification adjusting ring 60 such that a user would see it, are a plurality of numeral indicia 82. A user will consult the indicia to determine the level of magnification for the viewing optic. Also shown on the exterior of the magnification adjusting ring 60 are the holes 75 and 77.

FIGS. 7A-7H also show the groove 66 on the inner surface of the magnification adjusting ring 60. As set forth above, the groove 66 aligns with the holes 61, 62 and 63 of the scope body to engage with the ball bearings 71.

In operation, as a user rotates the magnification adjusting ring 60, a pin or screw-like mechanism, which engages the hole 77 and groove 68 of the scope body 12 moves within scope tube to adjust the magnification of the optic. The ball bearings 71 allow the magnification adjusting ring 60 to slide easily about the body 12.

In accordance with another embodiment of the disclosure, a method of retaining an adjusting ring, such as a magnification adjusting ring, on a viewing optic body is provided.

First, the body must include a plurality of holes. These holes may be drilled, tapped or formed in the body by any technology capable of forming the desired holes.

Second, an adjustment ring is placed over the body such that a groove on the interior of the adjustment ring aligns with the holes.

The adjustment ring further includes at least one hole through the ring and interrupting the groove. The adjustment ring is rotated about the body until the at least one hole aligns with at least one hole of the viewing optic body.

Once so aligned, a compressible material is pushed through the at least one hole of the adjusting ring into the corresponding hole in the body of the viewing optic. A ball bearing is then pushed through the hole of the adjusting ring to compress the compressible material. While that force is being applied to compress the compressible material, the adjusting ring is rotated to so that the hole aligns with the next hole of the viewing optic body.

The steps of rotating the adjusting ring until the at least one hole aligns with at least one hole of the viewing optic body, pushing the compressible material through the adjustment ring and into the viewing optic body, and pushing the ball bearing in are repeated until all holes in the viewing optic body contain a compressible material and a ball bearing.

While the magnification adjusting assembly has been described with reference to a rifle scope, it will be appreciated that the magnification adjusting assembly could easily be used with other viewing optics. Similarly, while the adjusting assembly and adjusting ring have been described with respect to adjusting magnification, it will be appreciated that other properties of a viewing optic and rifle scope can utilize the same concepts, structures and materials in order to retain any ring structure which adjusts a property of the viewing optic.

While various embodiments of the magnification adjusting ring have been described in detail, it should be apparent that modifications and variations thereto are possible, all of which fall within the true spirit and scope of the invention. With respect to the above description then, it is to be realized that the optimum dimensional relationships for the parts of the disclosed technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A magnification adjusting assembly comprising:
a ring having an inner surface and an outer surface;
a groove disposed around the inner surface of the ring; and
at least three ball bearing structures secured in the groove by a compressible material.

2. The magnification adjusting assembly of claim 1, wherein the compressible material is an o-ring.

3. The magnification adjusting assembly of claim 1 having a texture over at least a portion of the outer surface.

4. The magnification adjusting assembly of claim 1, wherein the outer surface further includes at least one fin.

5. The magnification adjusting assembly of claim 1, further comprising numerical indicia on a portion of the outer surface.

6. A viewing optic comprising:
a body having an outer surface and rear end comprising a plurality of holes spaced about the body;
a movable optical element defining an optical axis connected to the body;
an adjusting ring assembly comprising
a ring having an inner surface and an outer surface;
a groove disposed around the inner surface of the ring; and
a plurality of ball bearing structures, each corresponding to one of the plurality of holes,
wherein the ball bearing structures are secured between the groove and the respective hole by a compressible material.

7. The viewing optic of claim 6, wherein the ball bearings are secured between the groove and the respective hole such that from greater than 50% to 75% of the ball bearings remain below the outer surface of the body.

8. The viewing optic of claim 6, wherein the compressible material is an o-ring.

9. The viewing optic of claim 6, wherein the plurality of holes comprises three holes.

10. The viewing optic of claim 9, wherein the holes are positioned from 215°-235°, 300°-60° and 105°-115°, respectively.

11. The viewing optic of claim 6, wherein the viewing optic is a rifle scope.

12. The viewing optic of claim 6, wherein the adjusting ring is a magnification adjusting ring.

13. A method of retaining an adjusting ring on a viewing optic, the method comprising:
providing a viewing optic body with a plurality of holes;
placing an adjusting ring over the body such that a groove on the interior of the adjustment ring aligns with the plurality of holes;
rotating the adjusting ring about the body until at least one hole in the adjusting ring aligns with at least one hole of the body;
pushing a compressible material through the hole in the adjusting ring;
pushing a ball bearing through the hole and into the adjusting ring;
rotating the adjusting ring about the body while compressing the compressible material using the ball bearing; and
repeating the pushing a compressible material, pushing a ball bearing, and rotating the adjusting ring about the body while compressing the compressible material using the ball bearing until each of the plurality of holes contains a compressible material and a ball bearing.
